(19) United States
(12) Patent Application Publication
(10) Pub. No.: US 2019/0174580 A1
(43) Pub. Date: Jun. 6, 2019

(54) INFRARED PANEL RADIATOR AND PROCESS FOR PRODUCTION OF THE INFRARED PANEL RADIATOR

(71) Applicant: Heraeus Noblelight GmbH, Hanau (DE)

(72) Inventors: Lotta GAAB, Darmstadt (DE); Thomas PIELA, Hanau (DE); Christoph STERNKIKER, Hanau (DE); Jürgen WEBER, Kleinostheim (DE)

(21) Appl. No.: 16/320,752

(22) PCT Filed: Jul. 5, 2017
(86) PCT No.: PCT/EP2017/066707

§ 371 Date: Jan. 25, 2019

(30) Foreign Application Priority Data
Jul. 27, 2016 (DE) 102016113815.0

(51) Int. Cl. H05B 3/26; H05B 3/12

(52) U.S. Cl. CPC H05B 3/26; H05B 3/12; H05B 2203/013; H05B 2203/004; H05B 2203/005; H05B 2203/032; H05B 2203/017

(57) ABSTRACT

An infrared panel radiator includes a substrate made of an electrically insulating material. A printed conductor is applied to a surface to the substrate. The printed conductor is made of an electrically conductive resistor material that generates heat when current flows through it. A process for producing the infrared panel radiator includes: (a) providing the substrate; and (b) applying the printed conductor to a surface of the substrate. To produce an infrared radiator that features homogeneous radiation emission at high radiation power per unit area, the substrate is manufactured from a composite material including an amorphous matrix component and an additional component in the form of a semiconductor material. The printed conductor is provided as a form part with a fixed geometric shape. The printed conductor is applied to the surface of the substrate such that the printed conductor and the substrate are permanently connected to each other.

### CROSS REFERENCE TO RELATED APPLICATIONS

This application is a U.S. National Phase filing of international patent application number PCT/EP2017/066707 filed Jul. 5, 2017 that claims the priority of German patent application number 102016113815.0 filed Jul. 27, 2016. The disclosures of these applications are hereby incorporated by reference in their entirety.

### FIELD

The invention relates to infrared panel radiators, and processes for production of the same.

### BACKGROUND

Known infrared panel radiators often include multiple infrared emitters with a cylinder-shaped emitter tube made of quartz glass. In these panel radiators, the emitter tubes are appropriately arranged such that their longitudinal axes extend parallel to each other in a plane, whereby a two-dimensional lamp arrangement is attained whose geometry can be adapted to the geometry of heating goods to be irradiated. Usually, a coil-shaped resistor wire is situated inside the emitter tube that has no contact, or essentially no contact, to the emitter tube. The heat transfer from the resistor wire to the emitter tube takes place essentially by thermal radiation.

In addition, infrared panel radiators are known, in which a heating element is applied directly to a support (substrate). The substrate can have different special shapes; it can be designed, for example, to be plate-shaped, til-shaped, planar, tube-shaped or polyhedral. The heating element of these emitters is in direct contact with the support such that a heat transfer from the printed conductor to the support takes place mainly by heat conduction.

An infrared panel radiator of this type, in which an electrical resistor element is in direct contact with a substrate made of quartz glass, is known from WO 1999/025154 A1. The resistor element has, for example, a meandering shape and is applied by means of film, screen printing or thin layer printing technique to the substrate surface, and is then burned in. In this context, the printed conductor is in a two-dimensional direct contact with the quartz glass substrate such that the heat transfer from the resistor element to the quartz glass substrate takes place mainly by heat conduction and convection, which can have a positive impact on the power efficiency.

A substrate made of quartz glass possesses good corrosion, temperature, and temperature cycling resistance and is available at high purity. Accordingly, it is also well-suited for high-temperature heating processes with stringent requirements concerning the purity and inertness as the substrate material for an infrared emitter. However, as a matter of rule, quartz glass shows comparably low thermal conductivity and is even used as a heat insulator. Therefore, if the substrate walls are thin, there is a risk of inhomogeneous heat distribution, which, in an extreme case, can show up on the opposite substrate side as a pattern reflecting the shape of the electrical resistor element. This can be counteracted only by a high occupation density of printed conductors, though this is expensive. If the substrate walls are thick, the power efficiency and the response time suffer (this means rapid temperature changes are not possible as these require rapid heating and cooling of the substrate).

The printed conductors applied to the substrate usually have a small cross-sectional surface area such that they are expensive to manufacture and process only low resistance to mechanical stress. As a result, a faulty printed conductor may be applied to the substrate during the production process. The application of faulty printed conductors to a substrate is associated with large amounts of scrap and high production costs.

This applies, in particular, to printed conductors that are produced by means of printing techniques: for example, by means of screen printing or inkjet printing, in which possible faults in the heating element can be detected only after completion of the printing process and therefore after the application to the substrate. Moreover, the production of printed conductors is cost intensive, since the ink used for printing often contains high fractions of precious metals such as, for example, platinum, gold or silver.

It is common to apply printed conductors to a plastic film. However, a printed conductor that has been applied to a plastic material is disadvantageous in the production of infrared panel radiators in that it can be used only in a narrow temperature range, since plastic films typically have only limited temperature resistance. In particular, in the case of printed conductors forming the resistor element of a heating element, the use of printed conductor films has proven to be disadvantageous.

### SUMMARY

Aspects of the invention are based on the object to devise a simple and inexpensive process for production of an infrared panel radiator that shows homogeneous radiation emission at a high radiation power per unit area.

Additional aspects of the invention are based on the object to devise an infrared panel radiator that exhibits high radiation power per unit area and allows, in particular, thin substrate walls to be heated homogeneously.

In accordance with an exemplary embodiment of the invention, a method of producing an infrared panel radiator is provided. The method includes (a) providing a substrate made of an electrically insulating material; and (b) applying a printed conductor to a surface of the substrate. The printed conductor is made of a resistor material that is electrically conductive and generates heat when current flows through the resistor material. During step (a), the substrate is provided to be manufactured from a composite material that includes an amorphous matrix component and an additional component in the form of a semiconductor material. During step (b), the printed conductor is provided as a form part which is applied appropriately to the surface of the substrate such that the printed conductor and the substrate are permanently connected to each other.

In accordance with another exemplary embodiment of the invention, an infrared panel radiator is provided. The infrared panel radiator includes a substrate made of an electrically insulating material; and a printed conductor applied to a surface of the substrate. The printed conductor is made of a resistor material that is electrically conductive and generates heat when current flows through the resistor material. The substrate is manufactured from a composite material that includes an amorphous matrix component and an additional component in the form of a semiconductor material. The printed conductor is provided as a form part and is applied to the surface of the substrate such that the printed conductor and the substrate are permanently connected to each other.

### BRIEF DESCRIPTION OF THE DRAWINGS

The invention is best understood from the following detailed description when read in connection with the accompanying drawings. It is emphasized that, according to common practice, the various features of the drawings are not to scale. On the contrary, the dimensions of the various features are arbitrarily expanded or reduced for clarity. Included in the drawings are the following figures:

FIG. 1 is a schematic view of an infrared panel radiator with a pre-made printed conductor form part applied to its substrate surface in accordance with an exemplary embodiment of the invention;

FIG. 2 illustrates a process for production of an infrared panel radiator, in which a pre-made printed conductor is provided as a form part and is connected to the surface of the substrate in accordance with an exemplary embodiment of the invention;

FIG. 3 is a side view of another infrared panel radiator in which the surface that is occupied by a printed conductor has a layer of glass applied to it in accordance with an exemplary embodiment of the invention;

FIG. 4 is a side view of yet another infrared panel radiator in which the printed conductor is connected to the substrate surface by means of a glass solder in accordance with an exemplary embodiment of the invention; and

FIG. 5 is a side view of yet another infrared panel radiator in which the printed conductor and the substrate are connected to each other by mechanical means, by a process of pressing-in, in accordance with an exemplary embodiment of the invention.

### DETAILED DESCRIPTION

Exemplary aspects of the invention relate to processes for production of an infrared panel radiator having a substrate made of an electrically insulating material, whose surface has applied to it a printed conductor made of a resistor material that is electrically conductive and generates heat when current flows through it. Such processes include the steps of: (a) providing the substrate; and (b) applying the printed conductor to a surface of the substrate.

Exemplary infrared panel radiators within the scope of the invention show two- or three-dimensional emission characteristics; they are used, for example, for the polymerization of plastic materials, for the curing of lacquers, for the drying of paints on heating goods, for the thermal treatment of semiconductor wafers in the semiconductor or photovoltaics industries, etc.

Due to their special, in particular two-dimensional, emission characteristics, inventive infrared emitters are particularly easy to adapt to the geometry of a surface of heating goods to be heated such that a homogeneous irradiation of surfaces of heating goods with a two-dimensional or three-dimensional design is made feasible.

In contrast to infrared panel radiators, in which an electrical resistor element made of a resistor material is the actual heating element of the infrared panel radiator, the resistor element of the infrared panel radiators according to exemplary aspects of the invention is used to heat another component, which is referred to as “substrate” hereinafter. The heat transport from the electrical resistor element to the substrate can be based on heat conduction, convection and/or heat radiation.

Referring to processes for production of an infrared emitter, the object specified above is met according to the invention based on a process of the type mentioned above in that, according to process step (a), a substrate is provided that is manufactured from a composite material that includes an amorphous matrix component and an additional component in the form of a semiconductor material, and in that the printed conductor is provided as a form part with a fixed geometric shape, which, according to process step (b), is applied appropriately to the surface of the substrate such that printed conductor and substrate are permanently connected to each other.

The underlying rationale of the invention is that an infrared panel radiator with high radiation power, such as, for example, a radiation power of more than 150,000 W/m², can be manufactured particularly easily and inexpensively if, firstly, the infrared panel radiator is manufactured from a thermally excitable material and, secondly, the printed conductor is provided as a semi-finished product.

Providing the printed conductor as a pre-made form part of a fixed geometric shape allows manufacturing errors that may occur during the production of the printed conductor to be recognized early. In particular, in contrast to a printed conductor that is manufactured through the use of printing techniques, it is feasible to check the printed conductor form parts for their functional capability before the process step of joining them with the substrate. For example, it is easy to apply a voltage to the printed conductor, if same is a separate component. By this means, a faulty printed conductor can be rejected and this can be done before connecting the faulty printed conductor to the substrate such that less scrap is produced and the production costs can therefore be lowered by this method.

In contrast to printed conductors, a pre-made printed conductor that is provided in the form of a semi-finished product is associated with another advantage in that the use of cost intensive materials can be foregone, for example, expensive printing ink, which, firstly, often includes a high fraction of precious metals, for example, platinum, and, secondly, needs to meet strict requirements concerning its suitability as an ink.

A printed conductor can be produced through a variety of manufacturing methods, for example, punching, laser cutting, or casting. Preferably, the form part is manufactured from a metal sheet through the use of a thermal separating procedure or by punching. The use of thermal separating or punching procedures allows printed conductors to be manufactured in large quantities and thus contributes to keeping the material and production costs low.

Since various manufacturing methods can be used, even materials that are difficult or laborious to process by printing techniques can be processed to form a printed conductor. Since the printed conductor is manufactured from a resistor material that is electrically conductive and generates heat when current flows through it, the printed conductor acts as heating element. However, an infrared emitter that emits two-dimensionally and homogeneously at high radiation power is obtained only after the printed conductor is connected to the substrate. According to exemplary aspects of the invention, the printed conductor is applied to the surface of the substrate as a form part and is permanently connected to the substrate. In this context, the printed conductor can be joined to the substrate both by mechanical and thermal methods, or by use of a non-conductive layer. In the simplest case, the printed conductor is joined to the substrate in loose contact with each other.

The printed conductor acts as a “local” heating element such that at least a section of the substrate can be heated locally. The printed conductor is dimensioned appropriately such that it heats a part of the substrate that is manufactured from the composite material. In this context, the part of the substrate that is heated by the printed conductor is the actual infrared radiation-emitting element. Since the printed conductor in contact with the substrate is in direct contact with the substrate surface, a particularly compact and therefore inexpensively produced infrared panel radiator is obtained.

The heat transport from the electrical resistor element to the support rack takes place, mainly, by thermal conduction; but it can also be based on convection and/or thermal radiation.

Since the substrate includes an amorphous matrix component as well as an additional component in the form of a semiconductor material, a substrate is obtained that can assume an energy-rich, excited state, in which an emission of infrared radiation at high radiation power is particularly favoured. The composition of the composite material is selected appropriately such that the composite material forms the actual infrared radiation-emitting element. In this context, the composite material includes the following components: an amorphous matrix component, and an additional component.

The amorphous matrix component accounts for the largest fraction of the composite material in terms of weight and volume. The matrix component is decisive for the mechanical and chemical properties of the composite material, for example, the temperature resistance, the strength, and the corrosion properties thereof. Since the matrix component is amorphous—it preferably is formed of or includes glass—the geometrical shape of the substrate can be adapted to the existing requirements of the respective application of the infrared emitter more easily than a substrate made of crystalline materials.

The matrix component can be formed of or include undoped or doped quartz glass and, if applicable, can contain oxidic, nitridic or carbidic components aside from SiO₂ in an amount of maximally 10% by weight.

Moreover, according to aspects of the invention, an additional component, in the form of a semiconductor material, is embedded in the matrix component. It forms an inherent amorphous or crystalline phase that is dispersed in the amorphous matrix component.

A semiconductor includes a valence band and a conduction band that may be separated from each other by a forbidden band with a width of up to ΔE≈3 eV. The width of the forbidden band is, for example, for Ge 0.72 eV, Si 1.12 eV, InSb 0.26 eV, GaSb 0.8 eV, AlSb 1.6 eV, CdS 2.5 eV. The conductivity of a semiconductor depends on how many electrons from the valence band cross the forbidden band to reach the conduction band. Basically, only few electrons can cross the forbidden band and reach the conduction band at room temperature such that a semiconductor usually has only a low conductivity at room temperature. But the conductivity of a semiconductor depends essentially on its temperature. If the temperature of the semiconductor material rises, the probability that there is sufficient energy to elevate an electron from the valence band to the conduction band increases as well. Therefore, the conductivity of semiconductors increases with increasing temperature. Semiconductor materials show good electrical conductivity if the temperature is appropriate.

The additional component is distributed uniformly or specifically non-uniformly as a separate phase. The additional component is decisive for the optical and thermal properties of the substrate; to be more specific, it effects an absorption in the infrared spectral range, which is the wavelength range between 780 nm and 1 mm. The additional component shows an absorption that is higher than that of the matrix component for at least part of the radiation in this spectral range.

The phase areas of the additional component in the matrix act as optical defects and cause, for example, the composite material to appear black or grey-blackish by eye at room temperature, depending on the thickness of the layer. Moreover, the defects also have a heat-absorbing effect.

The type and amount of the additional component present in the composite material are preferably appropriate such as to effect, in the composite material at 600° C., an emissivity ε of at least 0.6 for wavelengths between 2 μm and 8 μm.

Particularly high emissivity can be attained if the additional component is present as an additional component phase and has a non-spherical morphology with maximal mean dimensions of less than 20 μm, but preferably of more than 3 μm.

In this context, the non-spherical morphology of the additional component phase also contributes to high mechanical strength and to a low tendency of crack formation of the composite material. The term “maximal dimension” shall refer to the longest extension of an isolated area of the additional component phase as visible in a microphotograph. The mean mentioned above is the median of all longest extensions in a microphotograph.

According to Kirchhoff's law of thermal radiation, the absorptivity α_{λ} and the emissivity ε_{λ} of a real body in thermal equilibrium are equal.

α_{λ}=ε_{λ} (1)

Accordingly, the additional component leads to the emission of infrared radiation by the substrate material. The emissivity ε_{λ} can be calculated as follows if the spectral hemispherical reflectance R_{gh} and transmittance T_{gh} are known:

ε_{λ}=1−R_{gh}−T_{gh} (2)

In this context, the “emissivity” shall be understood to be the “spectral normal degree of emission”. Same is determined by means of a measuring principle that is known by the name of “Black-Body Boundary Conditions” (BBC) and is published in “DETERMINING THE TRANSMITTANCE AND EMITTANCE OF TRANSPARENT AND SEMITRANSPARENT MATERIALS AT ELEVATED TEMPERATURES”; J. Manara, M. Keller, D. Kraus, M. Arduini-Schuster; 5th European Thermal-Sciences Conference, The Netherlands (2008).

The amorphous matrix component has a higher heat radiation absorption in the composite material (i.e., in combination with the additional component), as compared to when the additional component is absent. This results in an improved thermal conductivity from the printed conductor into the substrate, more rapid distribution of the heat, and a higher rate of emission towards the substrate. By this means, it is feasible to provide higher radiation power per unit area and to generate a homogeneous emission and uniform temperature field even for thin substrate walls and/or a comparably low printed conductor occupation density. A substrate with a low wall thickness has a low thermal mass and allows for rapid temperature changes. Cooling is not required for this purpose.

In a particularly preferred exemplary embodiment of a process according to the invention, the type and amount of the additional component present are such as to effect, in the composite material at a temperature of 1000° C., an emissivity ε of at least 0.75 for wavelengths between 2 μm and 8 μm.

Accordingly, the composite material has high absorption and emission power for thermal radiation between 2 μm and 8 μm, i.e., in the wavelength range of infrared radiation. This reduces the reflection at the surfaces of the composite material such that, on the assumption of the transmission being negligibly small, the resulting degree of reflection for wavelengths between 2 μm and 8 μm and at temperatures above 1000° C. is maximally 0.25 and at temperatures above 600° C. is maximally 0.4. Non-reproducible heating by reflected thermal radiation is thus prevented which contributes to a uniform or desired non-uniform temperature distribution.

It has proven expedient to generate the connection of printed conductor and substrate by a joining procedure such as, for example, mechanical joining, gluing, or welding.

Joining procedures mediate a permanent connection of at least 2 components. In this context, the connection between the components can be produced at least at individual joining sites. According to the exemplary embodiments of the invention, the printed conductor is present as a form part, which means it has a fixed geometric shape. The substrate can be present in a fixed geometric shape or as a shapeless substance when the printed conductor and the substrate are being joined. Preferably, the substrate also is present in a fixed geometric shape. By this means, the positioning of the printed conductor on the substrate is made particularly simple.

Advantageously, the printed conductor and the substrate can be connected to each other using, for example, mechanical joining, gluing, soldering, or welding. Referring to mechanical joining, press-in operations have proven to be particularly expedient. For this purpose, the substrate can be provided with a depression that corresponds to the shape of the printed conductor, for example, with a groove into which the printed conductor is pressed.

Alternatively, a glass substrate can be connected to a printed conductor using a glass solder. Glass solders are characterized by having a particularly low softening temperature; they can be used for production of heat-generated connections of materials to glasses. The manufacturing procedure resembles the soldering of metals, but glass solder connections are classified, systematically, as glued connections. Glued connections are advantageous in that they are particularly easy to produce. Moreover, the properties of the adhesive can be adjusted to match the material properties of the materials to be connected. For example, the thermal expansion coefficient of the adhesive (glass solder) is selected appropriately such that it is between the thermal expansion coefficient of the printed conductor and the thermal expansion coefficient of the substrate.

A welded connection is produced by introducing energy into the printed conductor and the substrate. In the process, both the printed conductor and the substrate are melted, at least in part, and become connected to each other when the melted region cools down.

An exemplary preferred modification of a process according to the invention provides the printed conductor to be connected to the surface of the substrate by a non-conductive layer.

A non-conductive layer acts as an electrical insulator; it can transport the heat generated by the printed conductor to the substrate, but it can hardly generate any heat. The non-conductive layer therefore contributes little to the heating of the substrate. The main input of energy takes place by means of the printed conductor such that the geometric shape of the printed conductor, firstly, defines the region of the substrate that is thermally excited and, secondly, determines the magnitude of heat input into the substrate. Therefore, deviations in the layer thickness of the non-conductive layer and, in particular, an inhomogeneous—possibly only partial—application of the non-conductive layer onto the substrate do not have a significant influence on the heat input into the substrate and the substrate temperature distribution.

It has proven to be beneficial to use a metal sheet made of silicon carbide (SiC), molybdenum disilicide (MoSi₂), tantalum (Ta) or high temperature-resistant steel to produce the form part.

The materials mentioned above, silicon carbide (SiC), molybdenum disilicide (MoSi₂), tantalum (Ta) or high-temperature-resistant steel, are inexpensive compared to precious metals, such as, for example, gold, platinum or silver. Moreover, the materials mentioned above can be processed in printing processes only with much effort, but they can be reshaped easily into a form body that can be used as a semi-finished product in the production of the infrared panel radiator. Moreover, these materials are advantageous in that they are oxidation-resistant on air such that an additional layer covering the printed conductor (cover layer) for protection of the printed conductor is not necessarily required.

However, it has proven to be beneficial to provide a cover layer that is manufactured from opaque quartz glass. A cover layer of this type acts as a diffuse reflector and concurrently protects and stabilises the printed conductor. The production of a cover layer of this type made of opaque quartz glass is described, for example, in WO 2006/021416 A1. It is generated from a dispersion containing amorphous SiO₂ particles in a liquid. This is applied to the substrate surface facing the printed conductor, dried to form a green layer, and the green layer is sintered at high temperature.

Advantageously, the form part includes a section with a spiral- or meander-shaped line pattern. By this means, uniform coverage of the substrate surface by a single printed conductor is made feasible. A single printed conductor is particularly easy to connect to and trigger from a source of current.

In an exemplary preferred modification of a process according to the invention, the application of the printed conductor to the surface of the substrate according to process step (b) is preceded by providing the form part, on its ends, with a conduction track, whose cross-sectional surface area is larger than the cross-sectional surface area of the line pattern.

Preferably, the line pattern extends in a plane. In order to simplify the electrical contacting of the printed conductor, it has proven to be advantageous for the printed conductor to have a lower temperature in the region of its electric contacting than in the heating region. To make this feasible, the printed conductor can be provided with a conduction track that has a larger cross-sectional surface area than the printed conductor. Due to its cross-sectional surface area being larger, the conduction track has a lower resistance; it is therefore heated significantly less strongly than the printed conductors themselves.

The printed conductor and the conduction track can form a unit that is provided as a single part or multiple parts. A one-part unit of printed conductor and conduction track can be manufactured in a single process step (e.g., by punching them from a metal sheet, by laser cutting, etc.). In this case, for example, the conduction track has a larger width than the printed conductor at a given thickness of the metal sheet. Alternatively, it is feasible just as well to connect the printed conductor and the conduction track in an additional process step before applying them as a unit to the surface of the substrate. For example, the conduction track and the printed conductor can be welded to each other.

It has proven to be expedient to provide contact elements at the ends of the printed conductor. Contact elements serve to simplify the electrical contacting of the printed conductor; they preferably form a plug element of a plug connection. The plug connection may be used for detachably connecting the contact element to a supply of electrical current. By this means, the printed conductor is particularly easy to disconnect from and to connect to an electrical lead, in particular to/from a current/voltage source.

In this context, it has proven to be beneficial to have the conduction track and the printed conductor be manufactured from the same material.

A connection of the conduction track and the printed conductor can be produced particularly easily if both components are manufactured from the same material, for example, by soldering.

Referring to the infrared panel radiator, the object specified above is met according to the invention based on an infrared panel radiator of the type mentioned above in that the substrate is manufactured from a composite material that includes an amorphous matrix component and an additional component in the form of a semiconductor material, and in that the printed conductor, as a form part with a fixed geometric shape, is applied appropriately to the surface of the substrate such that printed conductor and substrate are permanently connected to each other.

The infrared panel radiator according to exemplary embodiments of the invention includes, firstly, a substrate made of a material for thermal application and, secondly, a printed conductor with a fixed geometric shape that is connected to the substrate.

Since the printed conductor is a form part with a fixed geometric shape, it has a particularly high mechanical stability and, in addition, can be manufactured at high accuracy.

In contrast to printed conductors, a pre-made printed conductor that is provided in the form of a semi-finished product is associated with another advantage in that the use of cost intensive materials can be foregone, for example, expensive printing ink, which, firstly, often includes a high fraction of precious metals, for example, platinum, and, secondly, needs to meet strict requirements concerning its suitability as an ink.

The printed conductor can be produced through a variety of manufacturing methods, for example, punching, laser cutting, or casting. In combination with the substrate, the printed conductor forms an infrared emitter that emits two-dimensional and homogeneously; it acts as “local” heating element such that at least a partial section of the substrate can be heated locally. The printed conductor is dimensioned appropriately such that it heats a part of the substrate that is manufactured from a special material, namely a composite material that includes an amorphous matrix component and an additional component in the form of a semiconductor material. The composite material is the actual infrared radiation-emitting element. Since the substrate includes an amorphous matrix component as well as an additional component in the form of a semiconductor material, a substrate is obtained that can assume an energy-rich, excited state that particularly favours an emission of infrared radiation. With regard to the composition of the composite material, reference shall be made to the explanations provided above in the context of the process according to aspects of the invention

An exemplary preferred embodiment of the infrared panel radiator according to the invention provides multiple printed conductors with fixed geometric shape, which each can be electrically triggered individually, to be applied to the substrate.

The provision of multiple printed conductors makes feasible the individual triggering and adaptation of the irradiation intensity that can be attained with the infrared panel radiator. On the one hand, the radiation power of the substrate can be adjusted through suitable selection of the distances of neighbouring sections of printed conductor. In this context, sections of the substrate are heated to different degrees such that they emit infrared radiation at different irradiation intensities.

Alternatively, the printed conductors can be electrically controlled individually such as to operate them through different operating voltages or operating currents. It has been evident that, in particular, the edges of a substrate are often heated less strongly than the middle region of the substrate. One possible cause being that there is a larger temperature gradient in the edge region with respect to its surroundings such that the edge region cools down more rapidly than, for example, the middle region of the infrared panel radiator. Variation of the operating voltages and/or operating currents that are applied to the respective printed conductors allows for easy and rapid adjustment of the temperature distribution of the substrate.

It has proven expedient to have the amorphous matrix component be quartz glass and to have the semiconductor material be present in elemental form, whereby the weight fraction of the semiconductor material is in the range of 0.1% to 5%.

It has proven expedient in this context that the amorphous matrix component and the additional component possess electrically insulating properties at temperatures below 600° C.

Quartz glass is an electrical insulator and possesses not only high-strength, but also good corrosion, temperature, and temperature cycling resistance, and it is available at high purity. It is therefore a conceivable matrix material even in high-temperature heating processes with temperatures of up to 1,100° C. Cooling is not required.

The fine-particle areas of the semiconductor phase in the matrix act as optical defects and cause the substrate material to appear black or grey-blackish by eye at room temperature, depending on the thickness of the layer. On the other hand, the defects also have impacts on the overall heat absorption of the composite material. This is mainly due to the properties of the fine-distributed phases of the semiconductor that is present in elemental form, to the effect that, on the one hand, the energy between the valence band and the conduction band (bandgap energy) decreases with the temperature and, on the other hand, electrons are elevated from the valence band to the conduction band if the activation energy is sufficiently high, which is associated with a clear increase in the absorption coefficient. The thermally activated occupation of the conduction band leads to the semiconductor material being transparent to a certain degree at room temperature for certain wavelengths (such as from 1,000 nm) and becoming opaque at high temperatures.

Accordingly, the absorption and the emissivity can increase abruptly with increasing temperature of the composite material. This effect depends, inter alia, on the structure (amorphous/crystalline) and doping of the semiconductor.

Preferably, the additional component is elemental silicon. For example, pure silicon shows a notable increase in emission from approximately 600° C., reaching saturation from approximately 1,000° C.

The semiconductor material, and specifically the elemental silicon that is used preferably, therefore make the vitreous matrix material black and do so at room temperature, but also at elevated temperatures above, for example, 600° C. As a result, good emission characteristics in terms of a high broadband emission at high temperatures is attained. In this context, the semiconductor material, preferably the elemental silicon, forms its own Si phase that is dispersed in the matrix. The latter can contain multiple semi-metals or metals (but metals up to a maximum of 50 wt. %, better no more than 20 wt. %; each relative to the weight fraction of the additional component), whereby the composite material shows no open porosity, but at most a closed porosity of less than 0.5% and a specific density of at least 2.19 g/cm³. It is therefore well-suited for support racks, with regard to which purity or gas tightness of the material from which the support rack is manufactured are of the essence.

The heat absorption of the composite material depends on the fraction of the additional component. The weight fraction of the additional component should therefore preferably be at least 0.1%. On the other hand, if the volume fraction of the additional component is high, this can have an adverse effect on the chemical and mechanical properties of the matrix. Taking this into consideration, the weight fraction of the additional component is preferably in the range of 0.1 to 5%.

It has proven to be particularly expedient that the amorphous matrix component is quartz glass and preferably has a chemical purity of at least 99.99% SiO₂ and a cristobalite content of at most 1%. The cristobalite content of the matrix being low (i.e., 1% or less), ensures that the devitrification tendency is low and, therefore, that the risk of crack formation during use as an infrared panel radiator is low, which meets the strict requirements concerning the absence of particles, purity, and inertness that are usually evident in semiconductor production processes.

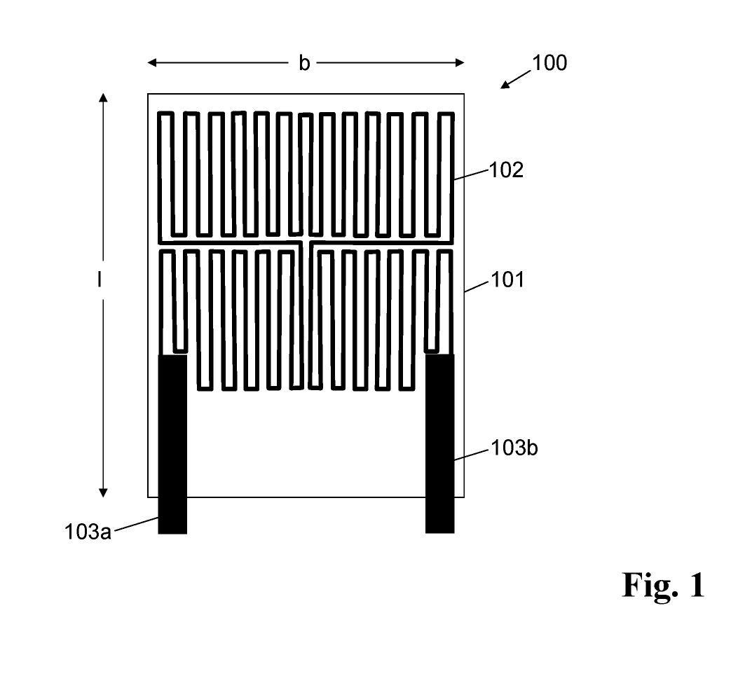

FIG. 1 shows a first embodiment of an infrared panel radiator according to the invention, which, in toto, has reference number 100 assigned to it. The infrared panel radiator 100 includes a plate-shaped substrate 101, a printed conductor 102, and two conduction tracks 103a, 103b for electrical contacting of the printed conductor 102.

The plate-shaped substrate 101 includes an amorphous matrix component in the form of quartz glass. A phase of elemental silicon is homogeneously distributed in the matrix component in the form of non-spherical areas. The exemplary plate-shaped substrate 101 has a length I of 100 mm, a width b of 100 mm, and a thickness of 2 mm.

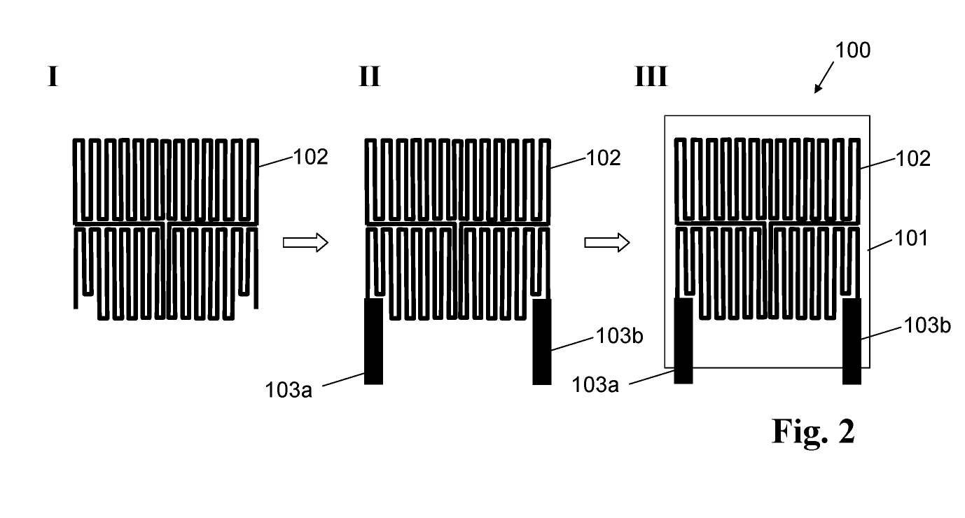

The printed conductor 102 is made from a single part; it forms a planar, areal, three-dimensional form part that is easy to place onto the plate-shaped substrate 101. The printed conductor 102 is manufactured from high temperature-resistant steel (2.4816) and is generated by punching it out of a steel plate. Each of the ends of the printed conductor 102 has a conduction track 103a, 103b arranged on it, which were punched out of the steel plates together with the printed conductor 102. In an alternative refinement of the infrared emitter according to the invention (not shown in FIG. 1), the conduction tracks 103a, 103b are welded to the ends of the printed conductor 102. The production process of an infrared panel radiator with welded-on conduction tracks shall be described in more detail in the following based on FIG. 2.

In as far as the same reference numbers as in FIG. 1 are used in the embodiments shown in other figures, these denote components and parts that are identical in design or equivalent as illustrated in more detail above by means of the description of the first embodiment of the infrared panel radiator according to the invention.

Based on FIG. 2, an example inventive process for production of the infrared panel radiator 100 is illustrated in more detail.

### Production of the Substrate 101 (Semi-Finished Product 1)

The production takes place in accordance with the slurry casting procedure, as described in WO 2015/067688 A1. Amorphous quartz glass grains are purified in advance in a hot chlorination procedure making sure that the cristobalite content is below 1% by weight. Quartz glass grains with grain sizes in the range of 250 μm to 650 μm are wet milled with deionized water such that a homogeneous basic slurry with a solids content of 78% is formed.

Then the milling beads are removed from the basic slurry and silicon powder is added until a solids content of 83% by weight is reached. The silicon powder predominantly contains non-spherical powder particles with a narrow particle size distribution whose D₉₇ value is approximately 10 μm and whose fine fraction of particle sizes of less than 2 μm was removed in advance.

The slurry filled with the silicon powder is homogenized for another 12 hours. The silicon powder accounts for a weight fraction of the total solids content of 5%. The SiO₂ particles in the ready-homogenised slurry have a particle size distribution that is characterised by a D₅₀ value of approximately 8 μm and a D₉₀ value of approximately 40 μm.

The slurry is cast in a die of a commercial die-casting machine and dewatered using a porous plastic membrane to form a porous green body. The green body has the shape of a rectangular plate. To remove bound water, the green body is dried at approximately 90° C. for 5 days in an aerated furnace. After cooling, the porous blank thus obtained is processed mechanically to be close to the final dimension of the quartz glass plate to be produced, which has a plate thickness of 4 mm. For sintering, the blank is heated over the course of 1 hour to a heating temperature of 1390° C. in a sintering furnace in the presence of air and maintained at this temperature for 5 hours.

The quartz glass plate thus obtained is the substrate 101. It includes a gas-tight composite material with a density of 2.1958 g/cm³, in which non-spherical regions of elemental Si phase that are separate from each other and whose size and morphology correspond essentially to those of the Si powder used in the process are homogeneously distributed in a matrix made of opaque quartz glass. The maximum mean dimensions (median) are in the range of approximately 1 μm to 10 μm. The matrix looks translucent to transparent to the eye. Upon microscopic inspection, it shows no open pores and at most closed pores with maximum mean dimensions of less than 10 μm; the porosity calculated based on the density is 0.37%. The composite material is stable on air up to a temperature of approximately 1,150° C.

### Production of the Printed Conductor 102 (Semi-Finished Product 2)

To produce the printed conductor 102, a form part intended to form the printed conductor is punched out of a tantalum sheet with a thickness of 0.2 mm, a width of 500 mm, and a length of 2000 mm. A punching tool in the form of a punch is used for punching, whereby a planar substrate is used as the counterpart. The punched-out printed conductor 102 has a meandering line profile and includes two meandering structures situated next to each other in a plane. FIG. 2, part I, shows the punched-out printed conductor 102. The printed conductors 102 extend over a length of 60 mm and a width of 60 mm.

### Welding of Printed Conductor 102 to Conduction Tracks 103a, 103b

The printed conductor 102 forms the so-called “hot” zone of the emitter in the finished infrared panel radiator 100. A “cold” zone is needed for the electrical contacting of the printed conductor 102. As shown in FIG. 2, part II, conduction tracks 103a, 103b are welded to the ends of the printed conductor 102 for this purpose. The conduction tracks 103a, 103b are provided such as to be identical; they have a length of 40 mm, a width of 5 mm, and a thickness of 0.4 mm.

Application of the Printed Conductor 102, Provided with the Conduction Tracks 103a, 103b, to the Substrate 101

FIG. 2, part III, shows the application of the printed conductor 102, provided with the conduction tracks 103a, 103b, to the substrate 101. Initially, the printed conductor 102 is placed on an upper side of the substrate 101. A glass solder is applied and then heated to the softening temperature such that liquid glass solder closes off the printed conductor 102 and the substrate surface. After the sintering of the glass solder, the printed conductor 2 and the substrate 101 are allowed to cool down while the glass solder bond is being formed.

### Application of a Reflector Layer (Optional)

Subsequently, a slurry layer is applied to the upper side of the substrate 101 and the printed conductor 102 that has been applied to it. This slurry is obtained by modification of the basic SiO₂ slurry of the type described above (without added silicon powder) by admixing to the homogeneous stable basic slurry amorphous SiO₂ grains in the form of spherical particles with a grain size of about 5 μm, until a solids content of 84% by weight is reached. This mixture is homogenized for 12 hours in a tumbling mill rotating at a rate of 25 rpm. The slurry thus obtained has a solids content of 84% and a density of approximately 2.0 g/cm³. The SiO₂ particles in the slurry obtained after milling of the quartz glass grains have a particle size distribution that is characterised by a D₅₀ value of approximately 8 μm and a D₉₀ value of approximately 40 μm.

The slurry is sprayed for several seconds onto the upper side of the substrate 101 that was cleaned in advance with alcohol. As a result, a homogeneous slurry layer with a thickness of approximately 2 mm is formed on the substrate 101. The dried slurry layer is free of cracks and has a mean thickness of a little less than 2 mm.

The dried slurry layer is then sintered on air in a sintering furnace.

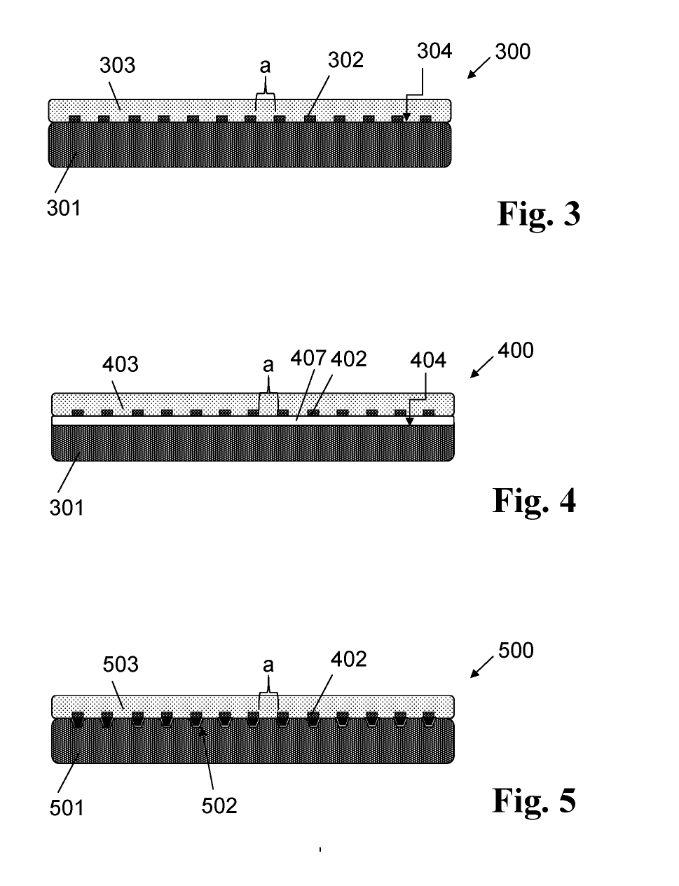

FIG. 3 shows a side view of a second exemplary embodiment of an infrared panel radiator according to the invention, which, in toto, has reference number 300 assigned to it. The infrared radiator 300 includes a plate-shaped substrate 301, a printed conductor 302, and a cover layer 303.

The plate-shaped substrate 301 has a rectangular shape and a plate thickness of 2.5 mm. It is formed of a composite material with a matrix made of quartz glass. The matrix looks translucent to transparent to the eye. Upon microscopic inspection, it shows no open pores and at most closed pores with maximum mean dimensions of less than 10 μm. A phase of elemental silicon is homogeneously distributed in the matrix in the form of non-spherical areas. These account for a weight fraction of 5% The maximum mean dimensions of the silicon phase areas (median) are in the range of approximately 1 μm to 10 μm. The composite material is gas-tight, it has a density of 2.19 g/cm³ and it is stable on air up to a temperature of approximately 1150° C.

The embedded silicon phase contributes not only to the overall opacity of the composite material, but also has an impact on the optical and thermal properties of the composite material. Said composite material shows high absorption of heat radiation and high emissivity at high temperature.

At room temperature, the emissivity of the composite material is measured using an integrating sphere. This allows for measurement of the spectral hemispherical reflectance R_{gh} and of the spectral hemispherical transmittance T_{gh} from which the normal emissivity can be calculated. The emissivity at elevated temperature is measured in the wavelength range from 2 to 18 μm by means of an FTIR spectrometer (Bruker IFS 66v Fourier Transformation Infrared (FTIR)) to which a BBC sample chamber is coupled using an additional optical system, applying the above-mentioned BBC measuring principle. In this context, the sample chamber is provided with thermostatted black body environments in the semi-spheres in front of and behind the sample holder, and with a beam exit opening with a detector. The sample is heated to a predetermined temperature in a separate furnace and, for the measurement, transferred into the beam path of the sample chamber with the black body environments set to the predetermined temperature. The intensity detected by the detector is composed of emission, reflection, and transmission portions, namely intensity emitted by the sample itself, intensity that is incident on the sample from the front hemisphere and is reflected by the sample, and intensity that is incident on the sample from the back hemisphere and is transmitted by the sample. Three measurements need to be performed to determine the individual parameters, i.e., the degrees of emission, reflection, and transmission.

The degree of emission measured on the composite material in the wavelength range of 2 μm to approximately 4 μm is a function of the temperature. The higher the temperature, the higher is the emission. At 600° C., the normal degree of emission in the wavelength range of 2 μm to 4 μm is above 0.6. At 1,000° C., the normal degree of emission in the entire wavelength range of 2 μm to 8 μm is above 0.75.

The printed conductor 302 is produced from a tantalum sheet by cutting the sheet into a form part with a laser beam. The form part has a fixed geometric shape; it has a one-part design and has the shape of an Archimedean spiral with the distance a of neighbouring sections of printed conductor 203 being 2 mm. The printed conductor 302 has a cross-sectional surface area of at least 0.02 mm² and a width of 1 mm and a thickness of 20 μm. Contacts made of tantalum (not shown) are welded to the printed conductor on both sides of the spiral. The contacts have a cross-sectional surface area of at least 0.5 mm². Since the contacts have a larger cross-sectional surface area than the printed conductor, they have a lower electrical resistance than the printed conductor 302; therefore, they are heated less strongly than the printed conductor 302 when current flows through them. The contacts therefore effect a lowering of the temperature such that the electrical contacting of the printed conductor 302 using the contacts is made simpler.

The printed conductor 302 is firmly connected to the substrate 301 in that a cover layer 303 made of glass is applied to the surface 304 of the substrate 301 that has been provided with the printed conductor. The cover layer 303 is manufactured from a glass whose thermal expansion coefficient is in a range between the thermal expansion coefficient of the substrate and the thermal expansion coefficient of the printed conductor. The thermal expansion coefficient of the substrate 301 is 0.54 10⁻⁶ K⁻¹; the thermal expansion coefficient of the printed conductor 302 is 6.4 10⁻⁶ K⁻¹; and the thermal expansion coefficient of the cover layer 303 is 0.54 10⁻⁶ K⁻¹. The cover layer 303 has a mean layer thickness of 1.8 mm. The cover layer 303 covers the entire heating area of the substrate 301. It covers the printed conductor 302 completely and thus shields the printed conductor 302 from ambient chemical or mechanical influences.

FIG. 4 shows a side view of a third exemplary embodiment of an infrared panel radiator according to the invention, which, in toto, has reference number 400 assigned to it. The infrared panel radiator 400 includes a substrate 301 of the type described in the description of FIG. 3, as well as a printed conductor 402 and a cover layer 403. The printed conductor 402 is connected to the substrate surface 404 using a glass solder 407.

Printed conductor 402 shows a meandering profile that covers a heating surface of the substrate 301 so tightly that an even distance of 1.5 mm remains between neighbouring sections of the printed conductor. In the cross-section shown, the printed conductor 402 has a cross-sectional surface area of 0.05 mm², a width of 1 mm and a thickness of 50 μm.

Glass solders are glasses with a low softening temperature; they belong to the group of adhesives. The processing procedure for glass solder resembles the soldering of metals. Due to its low softening temperature, the glass solder is liquid at a processing temperature. The substrate, though, is solid at the processing temperature.

The glass solder used is a glass paste made of glass powder and an organic binding agent, for example, glass solder no. G018-385 of Schott AG, Mainz, Germany. The glass solder has a thermal expansion coefficient α₍₂₀₋₃₀₀₎ of 8.4 ppm/K, a density of 3.14 g/cm³, a glass transition temperature of 992° C., and a melting temperature of 1,000° C.

During the production of the infrared panel radiator 400, the printed conductor is produced first as a form part by punching it from a sheet of high temperature-resistant steel. Subsequently, the surface of the substrate 301 is heated and a layer of glass solder is applied. The printed conductor 402 is placed on the glass solder layer and heated together with the glass solder layer until the glass solder layer softens such that a bond is generated, firstly between glass solder layer and substrate 301 and secondly between the glass solder layer and printed conductors 402, when the glass solder layer cools down. For protection from mechanical and chemical stress, the printed conductor 402 and the glass solder layer are finally provided with a cover layer 403 made of a transition glass, whose thermal expansion coefficient is in the range between the thermal expansion coefficient of the glass solder and the thermal expansion coefficient of the printed conductor 402.

FIG. 5 shows a side view of a fourth exemplary embodiment of an infrared panel radiator 500 according to the invention, in which the printed conductor 402 and the substrate 501 are connected to each other mechanically by a process of pressing-in.

The substrate 501 is manufactured from the same material as the substrate 301 of FIG. 3. It differs from the substrate 301 known from FIG. 3 in that the surface of the substrate 501 is provided with a groove 502 that corresponds to the geometrical shape of the printed conductor 402. The groove width at the base is 1.2 mm, the groove depth is 0.04 mm. The side surfaces of the groove 502 are somewhat slanted; this makes printed conductor 402 and substrate 501 easier to connect mechanically. A cover layer 503 made of quartz glass is applied to the surface of the substrate 502 and the printed conductor 402. In an alternative embodiment (not shown), no cover layer is provided. The function of the cover layer 503 is to protect the printed conductor 402 from chemical and mechanical influences. In particular printed conductors made of high temperature-resistant steel or molybdenum disilicide have high temperature resistance, such that a cover layer is dispensable.

Although the invention is illustrated and described herein with reference to specific embodiments, the invention is not intended to be limited to the details shown. Rather, various modifications may be made in the details within the scope and range of equivalents of the claims and without departing from the invention.

1. A method of producing an infrared panel radiator, the method comprising the steps:
(a) providing a substrate made of an electrically insulating material; and
(b) applying a printed conductor to a surface of the substrate, the printed conductor being made of a resistor material that is electrically conductive and generates heat when current flows through the resistor material,
wherein, during step (a), the substrate is provided to be manufactured from a composite material that includes an amorphous matrix component and an additional component in the form of a semiconductor material, and during step (b) the printed conductor is provided as a form part, which is applied appropriately to the surface of the substrate such that the printed conductor and the substrate are permanently connected to each other.

2. The method of claim 1 wherein during step (b) the printed conductor and the substrate are connected by at least one of mechanical joining, gluing, and welding.

3. The method of claim 1 wherein the printed conductor is connected to the surface of the substrate during step (b) using a non-conductive layer.

4. The method of claim 1, wherein the form part is manufactured from a sheet of metal through the use of a thermal separating process or by punching.

5. The method of claim 1, wherein a workpiece made of silicon carbide (SiC), molybdenum disilicide (MoSi₂), tantalum (Ta) or high temperature-resistant steel is used to produce the form part.

6. The method of claim 1, wherein prior to the applying of the printed conductor to the surface of the substrate in step (b), the form part is provided, on its ends, with a conduction track whose cross-sectional surface area is larger than a cross-sectional surface area of a line pattern of the printed conductor.

7. The method of claim 6, wherein the conduction track and the printed conductor are manufactured from the same material.

8. An infrared panel radiator comprising:
a substrate made of an electrically insulating material; and
a printed conductor applied to a surface of the substrate, the printed conductor being made of a resistor material that is electrically conductive and generates heat when current flows through the resistor material, wherein the substrate is manufactured from a composite material that includes an amorphous matrix component and an additional component in the form of a semiconductor material, and the printed conductor is provided as a form part and is applied to the surface of the substrate such that the printed conductor and the substrate are permanently connected to each other.

9. The infrared panel radiator of claim 8, wherein the printed conductor includes a plurality of printed conductor form parts applied to the substrate, wherein each of the printed conductor form parts can be electrically triggered individually.

10. The method of claim 2 wherein the printed conductor is connected to the surface of the substrate during step (b) using a non-conductive layer.

11. The method of claim 2, wherein the form part is manufactured from a sheet of metal through the use of a thermal separating process or by punching.

12. The method of claim 3, wherein the form part is manufactured from a sheet of metal through the use of a thermal separating process or by punching.

13. The method of claim 2, wherein a workpiece made of silicon carbide (SiC), molybdenum disilicide (MoSi₂), tantalum (Ta) or high temperature-resistant steel is used to produce the form part.

14. The method of claim 3, wherein a workpiece made of silicon carbide (SiC), molybdenum disilicide (MoSi₂), tantalum (Ta) or high temperature-resistant steel is used to produce the form part

15. The method of claim 4, wherein a workpiece made of silicon carbide (SiC), molybdenum disilicide (MoSi₂), tantalum (Ta) or high temperature-resistant steel is used to produce the form part

16. The method of claim 2, wherein prior to the applying of the printed conductor to the surface of the substrate in step (b), the form part is provided, on its ends, with a conduction track whose cross-sectional surface area is larger than a cross-sectional surface area of a line pattern of the printed conductor.

17. The method of claim 3, wherein prior to the applying of the printed conductor to the surface of the substrate in step (b), the form part is provided, on its ends, with a conduction track whose cross-sectional surface area is larger than a cross-sectional surface area of a line pattern of the printed conductor.

18. The method of claim 4, wherein prior to the applying of the printed conductor to the surface of the substrate in step (b), the form part is provided, on its ends, with a conduction track whose cross-sectional surface area is larger than a cross-sectional surface area of a line pattern of the printed conductor.

19. The method of claim 5, wherein prior to the applying of the printed conductor to the surface of the substrate in step (b), the form part is provided, on its ends, with a conduction track whose cross-sectional surface area is larger than a cross-sectional surface area of a line pattern of the printed conductor.
